(19) United States
(12) Patent Application Publication
(10) Pub. No.: US 2007/0275122 A1
(43) Pub. Date: Nov. 29, 2007

(54) Process for Controlling Foam

(76) Inventors: Henrique A. Cazaroto, Sao Paolo (BR); Jean-Paul Lecomte, Auderghem (BE); Takahiro Miura, Kanagawa Prefecture (JP); Marcel Rius, Nivelle (BE)

Correspondence Address: DOW CORNING CORPORATION CO1232, 2200 W. SALZBURG ROAD, P.O. BOX 994, MIDLAND, MI, 48686-0994, US

(21) Appl. No.: 10/576,771

(22) PCT Filed: Oct. 21, 2004
(86) PCT No.: PCT/US04/35370

§ 371 Date: Apr. 21, 2006

(30) Foreign Application Priority Data
Oct. 23, 2003 (GB) 0324673.3

(51) Int. Cl. B01D 19/04

(52) U.S. Cl. 426/49; 516/117

(57) ABSTRACT

Foam is controlled by the addition of a hydroxy-functional polydiorganosiloxane of viscosity 10 to 150 mPa·s during a fermentation process such as an aqueous alcoholic fermentation process, or during other fermentation systems and proteinaceous systems such as sugar beet processing.

This invention relates to a process for controlling foaming and to a foam control agent. In particular it relates to controlling foaming during an aqueous alcoholic fermentation process.

Fermentation processes have long been known for the production of beverages and more recently are being used for the preparation of alcohol for fuel from molasses, corn syrup or sugar cane juice. During the course of the fermentation, the microorganisms release carbon dioxide bubbles, which produce foam. The proteins which are in the fermentation broth stabilise the air/water interphase and thus stabilise the foam.

The main technology currently used in the fuel alcohol fermentation industry is based on the use of a “foam conditioner” made of a polyglycol, for example an ethylene oxide (EO)-propylene oxide (PO) copolymer and of mineral oil-based antifoam. This solution requires the use of two materials and the low persistency of these antifoam agents means that new antifoam material has to be added on a regular basis.

Silicones have been widely used as foam control agents in various industries. There have been suggestions to use silicones as foam control agents in fermentation processes. FR-A-2508471 describes a foam control agent comprising a polydimethylsiloxane of viscosity at least 20×10⁴ m²/sec., silca, polyoxypropylene, a nonionic surface active agent and a dispersion agent. U.S. Pat. No. 6,083,998 describes a defoamer comprising polydimethylsiloxane, an ethylene oxide propylene oxide block copolymer and a silicone/silica blend.

We have found according to the invention that certain silicones not usually employed as foam control agents are particularly effective in controlling foam in fermentation processes, particularly in the preparation of alcohol for fuel.

According to one aspect of the invention a process for controlling foaming during an aqueous alcoholic fermentation process comprises adding a hydroxy-functional polydiorganosiloxane of viscosity 10 to 150 mPa·s to the aqueous fermenting liquor.

The hydroxy-functional polydiorganosiloxanes of viscosity 10 to 150 mPa·s are miscible with many polyglycols, and we have found that such mixtures are also particularly effective in controlling foam in the preparation of alcohol for fuel. Thus according to another aspect of the invention a foam control agent for an aqueous alcoholic fermentation process comprises a blend of a hydroxy-functional polydiorganosiloxane of viscosity 10 to 150 mPa·s and a polyglycol with which the hydroxy-functional polydiorganosiloxane is miscible.

The hydroxy-functional polydiorganosiloxane is preferably a silanol-functional polydiorganosiloxane, particularly a silanol-terminated polydiorganosiloxane such as a silanol-terminated polydimethylsiloxane (PDMS). Siloxanes containing other organic groups linked to silicon such as 2-4C alkyl or phenyl can be used. The silanol-terminated PDMS preferably has a viscosity of at least 20 cSt (equivalent to about 20 mPa·s) up to about 50 cSt. ‘Dow Corning PA Fluid’ (Trade Mark), having a viscosity of about 42 cSt, is one example of a suitable fluid.

The hydroxy-functional polydiorganosiloxane can alternatively be a polydiorganosiloxane containing silicon-bonded hydroxyalkyl groups having 1 to 4 carbon atoms, for example methylol groups. Such hydroxyalkyl groups are preferably at the terminal position of the polydiorganosiloxane, but can alternatively be substituted elsewhere than at the terminal position.

The hydroxy-functional polydiorganosiloxane is preferably added at 5 to 250 parts per million by volume based on the aqueous fermenting liquor, for example at 10 to 200 μl per litre of fermenting liquor.

The hydroxy-functional polydiorganosiloxane can be added to the aqueous fermenting liquor unmixed with any additive. In one process according to the invention, a silanol-terminated polydiorganosiloxane is the only foam control added to the aqueous fermenting liquor.

Alternatively, a polyglycol with which the hydroxy-functional polydiorganosiloxane is miscible can also be added to the aqueous fermenting liquor. By “miscible” we mean that the polyglycol and the hydroxy-functional polydiorganosiloxane are miscible in the proportions used without requiring any emusifier or cosolvent. The polyglycol is a hydroxy-terminated polyether. The polyglycol can for example be of molecular weight 400 up to 4000. Many silanol-terminated polydiorganosiloxanes are miscible with hydroxy-terminated polyoxypropylene, hydroxy-terminated polytetramethylene oxide and hydroxy-terminated oxyethylene-oxypropylene copolymers. In general miscibility increases with decreasing viscosity of the polydiorganosiloxane and with decreasing molecular weight of the polyether. For example, silanol-terminated PDMS of viscosity up to about 50 mPa·s is miscible with polyoxypropylene of molecular weight 2000, but PDMS of viscosity 50 to 150 mPa·s is miscible with polypropylene glycol of lower molecular weight. The polyglycol can be added separately from the hydroxy-functional polydiorganosiloxane but is preferably added admixed with the hydroxy-functional polydiorganosiloxane, for example in a weight ratio of hydroxy-functional polydiorganosiloxane to polyglycol in the range 5:1 to 1:5.

The hydroxy-functional polydiorganosiloxane, or the mixture of polyglycol and hydroxy-functional polydiorganosiloxane, can be mixed with up to 50% by weight based on the hydroxy-functional polydiorganosiloxane of a branched silicone resin. The branched silicone resin is generally a non-linear siloxane resin and preferably consists of siloxane units of the formula R′ₐSiO_{4-a/2} wherein R′ denotes a hydroxyl, hydrocarbon or hydrocarbonoxy group, and wherein a has an average value of from 0.5 to 2.4. It preferably consists of monovalent trihydrocarbonsiloxy (M) groups of the formula R″₃SiO_{1/2} and tetrafunctional (Q) groups SiO_{4/2} wherein R″ denotes a monovalent hydrocarbon group. The number ratio of M groups to Q groups is preferably in the range 0.4:1 to 2.5:1, most preferably 0.5:1 to 0.8:1. The silicone resin can for example be present at 1 to 40%, preferably 5 to 30%, based on the hydroxy-functional polydiorganosiloxane. Such a silicone resin can enhance the foam control efficiency of the hydroxy-functional polydiorganosiloxane.

The hydroxy-functional polydiorganosiloxane, or the mixture of polyglycol and hydroxy-functional polydiorganosiloxane, can be mixed with up to 150% by weight based on the hydroxy-functional polydiorganosiloxane of a silicone polyether. The silicone polyether can for example be a silicone polyether block copolymer or a comb-type copolymer having polyether chains pendant to a silicone backbone. Examples of a suitable silicone polyether is sold under the Trade Mark ‘Dow Corning FS 1270’ and ‘Dow Corning FS83’. The silicone polyether is not required to compatibilise the hydroxy-functional polydiorganosiloxane and polyglycol but may enhance the foam control efficiency of the hydroxy-functional polydiorganosiloxane. The silicone polyether can for example be present at 1 to 100%, preferably 10 to 80%, based on the hydroxy-functional polydiorganosiloxane.

The hydroxy-functional polydiorganosiloxane, or the mixture of polyglycol and hydroxy-functional polydiorganosiloxane, can be mixed with up to 75% by weight based on the hydroxy-functional polydiorganosiloxane of a trialkylsilyl-terminated polydiorganosiloxane, for example a trimethylsilyl-terminated PDMS, although such a trialkylsilyl-terminated polydiorganosiloxane generally does not enhance the foam control efficiency of the hydroxy-functional polydiorganosiloxane. If used, the trialkylsilyl-terminated polydiorganosiloxane preferably has a viscosity in the range 5 to 250 mPa·s.

Conventional foam control agents generally contain hydrophobic fillers which are particulate materials solid at 100° C. such as silica. We have found that such fillers may enhance, but are not critical for the foam control efficiency of the hydroxy-functional polydiorganosiloxane in aqueous fermenting liquors. The hydroxy-functional polydiorganosiloxane added as foam control agent according to the invention preferably contains no solid particles.

The hydroxy-functional polydiorganosiloxane, and the polyglycol and any other additive to the silanol-terminated polydiorganosiloxane, can be added continuously or intermittently to the aqueous fermenting liquor. Intermittent addition of 5 to 250 μll foam control agent per litre of fermenting liquor every 10 to 60 minutes may be found most convenient.

In an alternative process, the hydroxy-functional polydiorganosiloxane, and the polyglycol and any other additive to the hydroxy-functional polydiorganosiloxane, are added initially to the aqueous fermenting liquor and an organic oil composition based on a hydrocarbon oil or vegetable oil is subsequently added to control foaming. Industrial scale fermentation tanks of 100,000 litres or more take a few hours to fill, and foam formation during filling of the tank is a particular problem. We have found that an initial charge of hydroxy-functional polydiorganosiloxane composition followed by subsequent additions of an organic oil based antifoam combine to give very efficient control of foaming. The organic oil can for example be a mineral oil such as a hydrogenated mineral oil or white oil, liquid polyisobutene, or an isoparaffinic oil, or can be a vegetable oil such as peanut oil, coconut oil, cottonseed oil or linseed oil. The organic oil can be mixed with a hydrophobic filler such as treated silica or ethylenebisstearamide, and/or a polyglycol.

The invention is illustrated by the following Examples, in which parts and percentages are by weight unless otherwise stated. The Examples will be described with reference to the accompanying drawings.

### DRAWINGS

FIG. 1 is a graph showing foam volume over time using the foam control agent of Example 1 or 2 according to the invention, or commercial foam control products currently used in the fuel alcohol fermentation industry, in the experimental test described in Example 1;

FIG. 2 is a graph showing foam volume over time when the foam control agent of Example 3 or 4 is used as initial foam control agent with subsequent addition of an organic oil antifoam compared to the use of a commercial foam control product currently used in the fuel alcohol fermentation industry in the experimental test of Example 3;

FIG. 3 is a graph showing foam volume over time when the foam control agent of Example 5 or 6 is used as initial foam control agent with subsequent addition of an organic oil antifoam compared to the use of a commercial foam control product currently used in the fuel alcohol fermentation industry in the experimental test of Example 3.

It should be understood, that the invention is not limited to only aqueous alcohol fermentation processes. It can also be used in other applications,. such as controlling foam in other fermentation systems, and proteinaceous systems including sugar beet processing. Thus, the foam control agent, i.e., the hydroxy-functional polydiorganosiloxane of viscosity 10 to 150 mPa·s, can be added to an aqueous liquor of a proteinaceous system such as the processing of sugar beets.

### EXAMPLES 1 AND 2

In Example 1, ‘Dow Corning PA Fluid’ silanol-terminated polydiorganosiloxane was used as foam control agent.

In Example 2, 50% ‘Dow Corning PA Fluid’ was mixed with 50% polypropylene glycol of molecular weight about 2000 to form a foam control agent.

A sparge test method was used to assess the antifoam efficiency of the foam control agents of Examples 1 and 2 compared to commercial products currently used in the fuel alcohol fermentation industry. The sparge test is made of a simple 1-liter graduated cylinder at the bottom of which an air diffuser is placed.

85.7 g molasses of 70% non-volatile content (NVC) were dispersed in 214.3 g of Orval (Trade Mark) beer to obtain 300 g of diluted molasses of 20° BRIX concentration: 45 g of yeast was dispersed in 55 g of Orval beer and pH was adjusted to 2.0 by addition of HCl aliquots. Beer is used to better reproduce the fermentation broth, as alcohol is produced as soon as the fermentation starts. 300 g of the molasses dispersion was blended with 100 g of the yeast dispersion to form an aqueous fermenting liquor. 400 ml of the aqueous fermenting liquor was poured into the cylinder. The antifoam (initially 20 μl) was added at the extremity of a Teflon rod, which is then introduced in the cylinder. The aqueous fermenting liquor was agitated to ensure good dispersion of the foam conditioner. The air diffuser was then placed at the bottom of the cylinder to start the experiment. Foam levels were recorded as a function of time. Once the foam level reached the top of the cylinder, additional antifoam was added to control the foam.

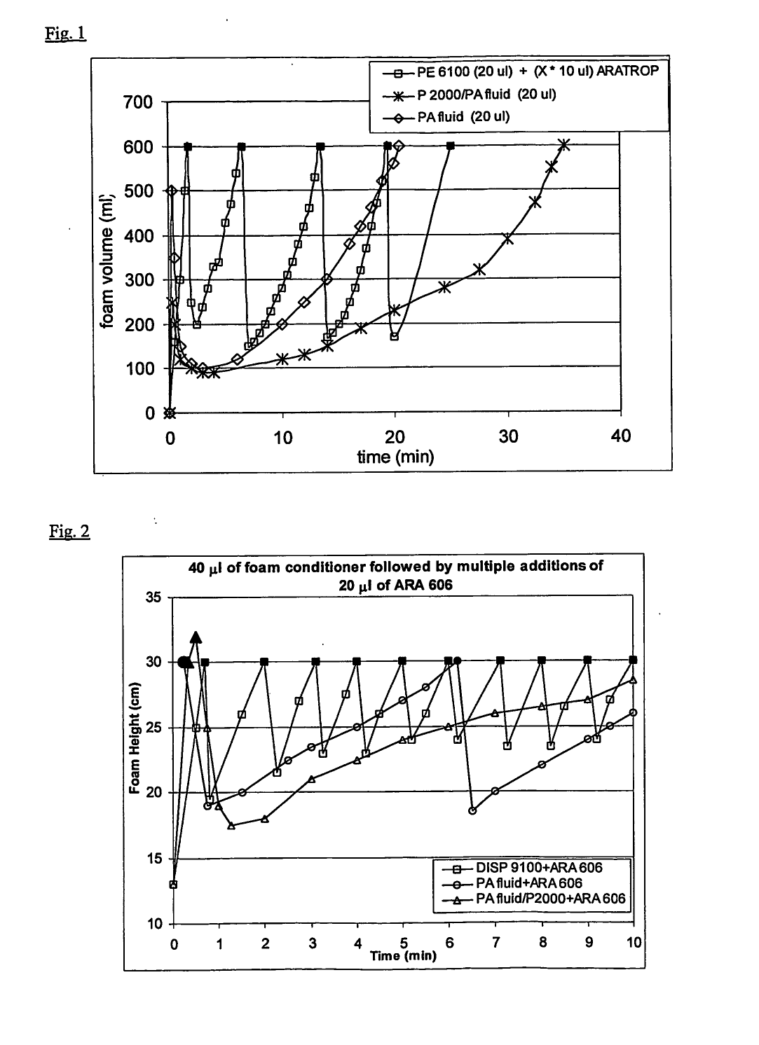

FIG. 1 shows that 20 microliter of ‘Dow Corning PA Fluid’ is required to control the foam during 20 minutes

FIG. 1 also shows that addition of 20 microliters of the blend of 50% ‘Dow Corning PA Fluid’ and 50% polypropylene glycol as foam control agent enables the foam to be controlled during 35 minutes, demonstrating even better antifoam efficiency.

In the comparative experiment, 20 microliter of ‘Pluronic PE 6100’ (Trade Mark) hydroxy-terminated oxyethylene-oxypropylene copolymer was used initially as the foam conditioner and subsequent additions of 10 microliter of ‘ARATROP 505’ (Trade Mark) mineral oil based antifoam commercial product, these being the proportions in which these materials are added in commercial practice. FIG. 1 shows that in order to control the foam during 20 minutes, the required antifoam content is 20 microliter of Pluronic PE 6100 and 40 microliters of ARATROP oil-based antifoam, for a total of 60 μl of foam control agent. The amount of ‘Dow Corning PA fluid’ required to control the foam during 20 minutes is thus three times less than the reference material.

### EXAMPLES 3 AND 4

The foam control agents of Examples 1 and 2 were each used as a “foam conditioner”, that is to say they were added to a fermenting liquor as the initial foam control followed by addition of an organic oil antifoam.

The foam control agents were tested in a sparge test column of which bottom is made of glass fritt. Air is blown through the fritt to generate air bubbles during the experiment. Solid yeast was dispersed in water to reach a 40% solid content and pH was adjusted to 2.0 by addition of HCl aliquots. Sugar cane molasses was diluted till a 24 Brix solution is obtained. 300 ml of the yeast dispersion was blended with 600 ml of the sugar syrup in a beaker. 40 μl of the foam control agent (“foam conditioner”) were added and gently dispersed with a spatula All the liquid is poured in the column. Air flow was then started, with a flow rate of 10 l/min. When the foam level reached a given limit (set arbitrarily at 30 cm cylinder height), ‘Aratrop 606’ (Trade Mark) organic oil antifoam comprising mineral oil and ethylenebisstearamide was added (20 μl at a time). Foam collapse was followed by further foam increase, leading if necessary to further organic oil antifoam addition. The test was finished after 10 minutes. The results are shown in FIG. 2.

In the above test of Example 3, where PA fluid is used initially as “foam conditioner”, 40 μl of the organic oil antifoam were needed over 10 minutes (required foam control agent: 40 μl PA fluid+40 μl ARATROP 606)

In the test of Example 4, where a mixture of 50% ‘Dow Corning PA Fluid’ and 50% polypropylene glycol was used as foam conditioner, addition of 40 microliters of organic oil antifoam enables the foam to be controlled during 10 minutes (required foam control agent: 40 μl PA fluid/P2000+40 μl ARATROP 606).

By comparison, when the polyglycol blend DISP 9100 (Trade Mark) was used alone as initial foam conditioner, 200 μl of the organic oil antifoam were needed over 10 minutes (required foam control agent: 40 μl DISP 9100+200 μl ARATROP 606).

### EXAMPLE 5

40% ‘Dow Corning PA Fluid’ was mixed with 40% of the polypropylene glycol of molecular weight about 2000 and 20% ‘Dow Corning FS 1270’ silicone polyether to form a foam control agent.

### EXAMPLE 6

45% ‘Dow Corning PA Fluid’ was mixed with 45% of the polypropylene glycol of molecular weight about 2000 and 10% ‘Dow Corning DC 9138’ branched silicone resin to form a foam control agent

The foam control agents of Examples 5 and 6 were each tested in the sparge test described in Example 3 but using a sugar cane coming from a different origin.

In Example 5, only 20 μl of the organic oil antifoam was needed over 10 minutes (required foam control agent: 40 μl foam conditioner from example 5+20 μl ARATROP 606).

In Example 6 also, only one addition of 20 μl of the organic oil antifoam was needed (required foam control agent: 40 μl foam conditioner from example 6+20 μl ARATROP 606).

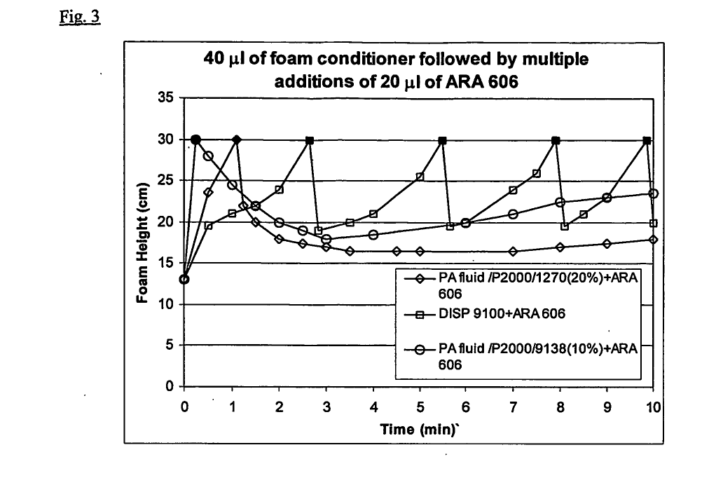

The results of the tests of Examples 5 and 6 are shown in FIG. 3 compared to the use of DISP 9100 (Trade Mark) blend of polyglycols is added originally as foam conditioner. Four additions of organic oil antifoam were needed to control the foam for 10 minutes when DISP 9100 was added originally as foam conditioner (required foam control agent: 40 μl DISP 9100+80 μl ARATROP 606).

1. A process for controlling foaming during an aqueous fermentation process, an aqueous alcoholic fermentation process, or a proteinaceous fermentation process, comprising adding to the process (i) a hydroxy-functional polydiorganosiloxane having a viscosity of 10-150 mPa·s at 25° C., (ii) a polyglycol with which the hydroxy-functional polydiorganosiloxane is miscible, (iii) a branched silicone resin, and (iv) a silicone polyether.

2. A process according to claim 1 including subsequently adding to the process (v) an organic oil composition based on a hydrocarbon oil or vegetable oil.

3. A process according to claim 1 including adding to the process (v) a trialkylsilyl-terminated polydiorganosiloxane.

4. A foam control agent comprising a blend of (i) a hydroxy-functional polydiorganosiloxane having a viscosity of 10-150 mPa·s at 25° C., (ii) a polyglycol with which the hydroxy-functional polydiorganosiloxane is miscible, (iii) a branched silicone resin, and (iv) a silicone polyether.

5. A foam control agent according to claim 4 including (v) an organic oil composition based on a hydrocarbon oil or vegetable oil.

6. A foam control agent according to claim 4 including (v) a trialkylsilyl-terminated polydiorganosiloxane.
